(19) United States
(12) Patent Application Publication
(10) Pub. No.: US 2003/0035922 A1
(43) Pub. Date: Feb. 20, 2003

(54) Manufacture of abrasion resistant composite extrusions

(76) Inventors: Zuoxing Yu, Stratford (CA); Tim Pauli, Stratford (CA); John Seward, Stratford (CA); Ted Ebel, Stratford (CA)

Correspondence Address: Timothy E. Nauman, Esq., Fay, Sharpe, Fagan,, Minnich & McKee, LLP, 1100 Superior Avenue, 7th Floor, Cleveland, OH, 44114-2518, US

(21) Appl. No.: 09/910,337

(22) Filed: Jul. 20, 2001

(51) Int. Cl. B32B 3/04

(52) U.S. Cl. 428/122; 428/516

(57) ABSTRACT

Methods for forming a composite extrusion for use as a glass run channel in an automobile and the products formed thereby are disclosed in which a main body member is formed from an elastomeric thermoset rubber and an abrasion resistant layer comprised of a crosslinkable thermoplastic or a high ethylene content EPDM rubber extruded thereon. The crosslinkable thermoplastic may be a moisture crosslinkable polyethylene containing grafted silane functional groups. The abrasion resistant layer may be extruded onto the thermoset either prior to or after the thermoset is cured and either prior to or after the abrasion resistant layer is crosslinked. The material of the abrasion resistant layer may be extruded into tape form and laminated onto the main body member.

### BACKGROUND OF THE INVENTION

1. Field of the Invention

The present invention relates to a process for forming composite extrusions and the products formed thereby, particularly glass run channel composites. More particularly, the present invention pertains to glass run channel composite extrusions comprised of an elastomeric thermoset and either a crosslinkable thermoplastic or a crosslinkable high ethylene content EPDM.

2. Discussion of the Art

It is common in the motor vehicle industry to fashion sealing sections for various parts of an automobile by extruding such sections from certain thermosetting polymeric materials. Examples of typical sealing sections manufactured by such a process include glass run channels. These glass run channels are mounted in the window frames of automobile doors to provide a seal between the door and the glass as well as to hold the glass snugly in the window frame.

Various thermoset elastomeric materials, such as ethylene-propylene-diene terpolymer (EPDM) and styrene-butadiene copolymer rubber (SBR), have been used to form these glass run channels. These materials are favored by manufacturers because they are relatively inexpensive compared to thermoplastics and generally exhibit the desired flexibility necessary for providing an effective seal and acceptable weatherability properties. However, these elastomers typically lack the low-friction, abrasion resistance that is necessary at the point of contact with the window glass for extended life of the channel.

Manufacturers have therefore attempted a variety of approaches to improve the wear resistance of elastomeric sealing sections. One such strategy used in the manufacture of glass run channels has been to apply a coating of low friction polymer to the surface of the elastomeric glass run channel along the area that contacts the glass. These coatings are usually applied directly to the channel surface as a solvent-based spray or after an application of a primer or adhesive layer to the elastomer. However, this method is not completely satisfactory. In addition to longer processing time and added material cost, it is difficult to obtain a satisfactory bond between the elastomer and the surface coating. Sprayed on coatings are prone to cracking while an adhered layer is susceptible to peeling.

Another method that manufacturers have used to improve the wear resistance of extruded glass run channels is to cohesively bond a layer of wear resistant thermoplastic to the elastomeric portion of the glass run channel. Several techniques have been developed to accomplish this. According to one method, the elastomer rubber and the thermoset are co-extruded. The laminate is then passed through an oven in which the elastomer rubber is cured and the interface between the thermoset and the rubber is heated to such a degree that the thermoset partially melts, causing it to adhesively bond with the rubber. Alternately, the rubber is extruded first and passes through an oven in which it is partially cured. A preheated thermoplastic is then extruded onto the vulcanized rubber. The residual heat of the rubber melts the thermoplastic at the interface between the two, forming a bond between the two materials.

One thermoplastic that is often used in this process is ultra high molecular weight polyethylene (UHMWPE) due to its superior abrasion resistance and good affinity with EPDM. Commonly, the UHMWPE is purchased in tape form and applied onto the elastomer rubber part. Although this tape provides satisfactory results, it is relatively expensive and increases the cost of production. In addition, due to its ultra high molecular weight, the tape does not effectively melt when splicing the joints of the ends of different spools together. This difficulty in joining two tape spools together in line causes production inefficiency and waste.

Thus, there is a need for a new method for producing glass run channel composites that overcomes the deficiencies and limitations of the prior art.

### BRIEF SUMMARY OF THE INVENTION

The present invention provides a process for forming an extruded glass run channel comprising a main body member of elastomeric rubber and an abrasion resistant layer, the abrasion resistant layer comprising a crosslinkable polyolefin or crosslinkable high ethylene content EPDM. In one embodiment, the elastomeric rubber is EPDM and the crosslinkable polyolefin is a moisture curable polyethylene. The crosslinkable polyethylene may contain grafted silane functional groups. In the presence of moisture, water hydrolyzes the silane. Under the action of a catalyst, the resulting silanol groups then condense to form intermolecular crosslinking sites. Alternately, crosslinkable high ethylene content EPDM may be used as the abrasion resistant layer. Preferably, the high ethylene content EPDM contains from about 70 to about 95 weight percent ethylene and from about 3 to about 11 weight percent ethylidene norbornene (ENB) and has a crystallinity of from about 8% to about 36%. The EPDM may be cured by sulfur or peroxide agents. The crosslinkable polyolefin or the crosslinkable high ethylene content EPDM can be applied to the elastomer rubber main body member by extruding the material directly onto the rubber or by extruding the material into a tape form and applying the tape to the EPDM by means of a laminating technique.

The crosslinkable polyolefin layer provides all the advantages of UHMWPE tape, including comparable toughness, without the high cost and splicing difficulties typically associated with such tape. The versatility of such material allows it to be applied to the elastomer rubber member in several ways. In a first preferred technique, the crosslinkable polyethylene is co-extruded with an uncured EPDM main body member and then exposed to water to crosslink the polyethylene. In a second technique, the crosslinkable polyethylene is extruded into a tape form and crosslinked by immersion in a water bath, or otherwise exposed to water. Subsequently, the tape is then laminated to an uncured EPDM main body member via a lamination die. The resulting composite is then passed through an oven to cure the EPDM. In a third technique, the crosslinkable polyethylene is extruded onto a cured or partially cured EPDM main body member. The resulting composite is then passed through a water bath, or otherwise exposed to water, to crosslink the polyethylene. In a fourth preferred technique, the crosslinkable polyethylene is extruded into a tape form and laminated onto a cured or partially cured EPDM member. The resulting composite is then immersed in a water bath, or otherwise exposed to water, to crosslink the polyethylene.

While all the techniques produce acceptable results, if the polyethylene is applied to the EPDM prior to the curing of the EPDM, the polyethylene should be crosslinked before the EPDM may be cured. This is to ensure that the polyethylene does not melt excessively during the heating. In the first two above noted techniques, the crosslinkable polyethylene may be replaced with the noted crosslinkable high ethylene content EPDM material with similar results.

### BRIEF DESCRIPTION OF THE DRAWINGS

FIG. 1 is a cross section of a preferred embodiment glass run channel for an automobile in accordance with the present invention.

FIG. 2 is a preferred cross section of another embodiment glass run channel for an automobile in accordance with the present invention.

FIG. 3 is a depiction of a first preferred technique of the present invention for manufacturing a composite extrusion suitable for use as glass run channel for an automobile.

FIG. 4 is a depiction of an alternative preferred technique of the present invention for manufacturing a composite extrusion suitable for use as a glass run channel for an automobile.

FIG. 5 is a depiction of an another alternative preferred technique of the present invention for manufacturing a composite extrusion suitable for use as a glass run channel for an automobile.

FIG. 6 is a depiction of yet another alternative preferred technique of the present invention for manufacturing a composite extrusion suitable for use as a glass run channel for an automobile.

FIG. 7 is a flowchart depicting the main processing steps in the first preferred technique of the invention detailed in FIG. 3.

FIG. 8 is a flowchart depicting the main processing steps in the second preferred technique of the invention detailed in FIG. 4.

FIG. 9 is a flowchart depicting the main processing steps in the third preferred technique of the invention detailed in FIG. 5.

FIG. 10 is a flowchart depicting the main processing steps in the fourth preferred technique of the invention detailed in FIG. 6.

### DETAILED DESCRIPTION OF PREFERRED EMBODIMENTS

The present invention provides a variety of sealing strips and glass run channels. Briefly, the glass run channels preferably comprise at least two components, each formed from particular materials and having a unique cross-sectional configuration. A preferred glass run channel comprises a thermoset elastomer rubber main body member having a bottom wall and two transversely extending side walls. Disposed at the distal ends of the pair of side walls, opposite from the bottom wall, are a pair of sealing lips. Together, the bottom wall, side walls, and sealing lips define an interior chamber that receives and retains an edge or portion of a glass window.

The glass run channel also comprises a layer of an abrasion resistant material disposed on the top surface of the bottom wall. The layer is exposed to and faces the interior chamber. As explained in greater detail below, the layer preferably comprises a moisture crosslinkable polyolefin or a high ethylene content EPDM rubber.

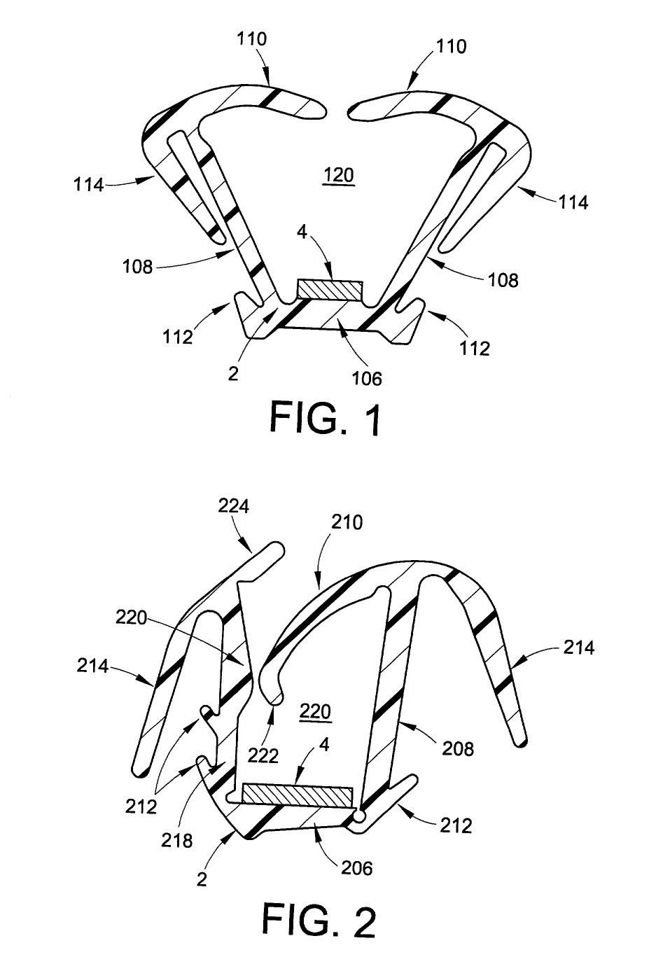

With reference to FIGS. 1 and 2, cross-sections of two preferred embodiment glass run channels for an automobile in accordance with the present invention are shown. The preferred glass run channels are comprised of a main body member 2, made from one or more of a number of elastomeric thermoset rubbers known in the art to be suitable for glass run channel applications, and an abrasion resistant layer 4. Examples of suitable elastomeric thermoset rubbers for use in forming the main body member 2, include, but are not limited to, ethylene-propylene-diene terpolymer (EPDM) rubber, styrene butadiene copolymer rubber, acrylonitrile-butadiene rubber, and natural or synthetic isoprene rubber. A preferred elastomer is EPDM. The elastomer can include a range of additives known in the art such as calcium carbonate, carbon black, clay, and silica in any concentration that does not adversely affect the properties of the elastomer.

In one preferred embodiment (FIG. 1), the main body member 2 is formed having a bottom wall 106 joined on either longitudinal side to a transverse side wall 108. The bottom wall has a top and bottom surface (not numbered). Attached to the distal end of the side walls and projecting inward therefrom are generally symmetrical sealing lips 110 to engage and seal against a car window (not shown). Together, the bottom wall 106, side walls 108, and sealing lips 110 define an interior chamber 120 that receives and retains an edge or portion of a glass window (not shown). Projecting outward from either side wall 108 are one or more relatively short upwardly directed retention spurs 112 and generally longer downwardly directed retention spurs 114 which function to hold the glass run channel securely in the vehicle door frame and sash (not shown). Preferably, the upwardly directed retention spurs 112 are located adjacent the bottom wall 106. The downwardly directed retention spurs 114 generally project substantially parallel to the side walls 108.

In a second preferred embodiment (FIG. 2), the main body member 2 is formed having a bottom wall 206 joined on either longitudinal side to a pair of substantially vertical side walls, 208 and 218. The bottom wall has a top and bottom surface (not numbered). A first side wall 208 is substantially straight and of uniform thickness from its base to its top (not numbered). Attached to the upper end of the first side wall 208 and projecting inward and slightly downward therefrom is a sealing lip 210 to engage and seal against a car window (not shown). The second side wall 218 has a protruding area 220 adjacent to the tip 222 of the sealing lip 210 that, along with the sealing lip, assists in securely holding a window (not shown). Projecting upward and inward from a second side wall 218 is a second sealing lip 224 that provides an additional point of contact to snugly hold the window. Together, the bottom wall 206, side walls 208 and 218, and sealing lips 210 and 224 define an interior chamber 220 that receives and retains an edge or portion of a glass window (not shown). Projecting outward from either side wall, 208 and 218, are one or more relatively short upwardly directed retention spurs 212 that function to hold the glass run channel securely in the vehicle door frame and sash (not shown). Also projecting outward from each side wall, 208 and 218, is a downwardly directed retention spur 214. These retention spurs 214 preferably extend generally downward toward the bottom wall 206. Two different embodiments of the invention have been described. Depending on the make of the automobile and the shape of the window and door frame, many alternative embodiments are also contemplated.

Irrespective of the exact shape of the main body member, extruded onto the upwardly directed top surface (not numbered) of the bottom wall, 106 in FIG. 1 and 206 in FIG. 2, of the main body member 2 is the abrasion resistant layer 4 comprised of a crosslinkable thermoplastic or a crosslinkable high ethylene content EPDM. This abrasion resistant layer 4 is applied along the glass run channel at those areas that contact the glass (not shown) to improve the wear resistance of the glass run channel at those locations. In addition, the abrasion resistant layer 4 may be extruded onto other areas of the main body member 2 that contact the glass window for added protection and scuff resistance, such as the top surfaces (not numbered) of the various sealing lips, 110, 210 and 224.

As explained in greater detail herein, in the final composite extrusion, such as incorporated into a door or window assembly, the abrasion resistant layer comprising at least one crosslinkable thermoplastic or a crosslinkable high ethylene content EPDM, is at least partially crosslinked. Thus, although much of the description herein refers to the abrasion resistant layer as comprising a crosslinkable material (as noted above), it will be understood that in its preferred final manufactured form, the composite extrusion of the present invention utilizes an abrasion resistant layer that comprises an at least partially crosslinked material.

In a particular embodiment of the invention, the abrasion resistant layer 4 is comprised of a crosslinkable thermoplastic. A preferred thermoplastic is a moisture crosslinkable polyolefin. A particularly desirable composition is a crosslinkable high density polyethylene that can be crosslinked by electron beam radiation or by a one or two-stage silane crosslinking process. Electron beam radiation crosslinking is not preferred because of its expense. However, it is contemplated that the present invention composite extrusion and related methods could utilize such a technique for crosslinking. One stage silane crosslinking involves the extrusion of a direct mixture of polyethylene resin with a silane concentrate that includes a catalyst. The extrudate is subsequently crosslinked in the presence of water. In two stage crosslinking, silane is first grafted to the polyethylene molecular chains according to known reactions to yield silane grafted polyethylene.

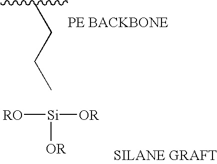

Subsequently, the silane-grafted polyethylene is mixed with a silanol condensation catalyst and then exposed to water to effect crosslinking of the silane grafted polyethylene in a two step reaction. First, the water hydrolyzes the silane to produce a silanol. The silanol then condenses to form intermolecular, irreversible Si—O—Si crosslink sites.

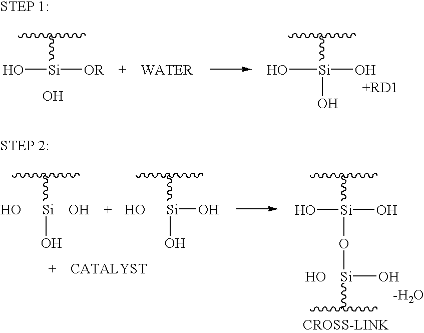

The amount of crosslinked silane groups, and thus the final polymer properties, can be regulated by controlling the production process, including the amount of catalyst used. A gel test (ASTM D2765) is used to determine the amount of crosslinking. Prior to being silane grafted, the polyethylene may have a melt flow index similar to other extrusion grades of polyethylene, for example 1.5 g/10 min as per ASTM D1238. After being silane grafted, however, the melt flow index is dramatically reduced, for example to 0.2 g/10 min. The catalyst can be any of a wide variety of materials that are known to function as silanol condensation catalysts including many metal carboxylates and fatty acids. Both a silane grafted base resin and catalyst suitable for the present application are available from AT Plastics Corp., Brampton, Ontario, under the trade names Flexet® 5100 for the base resin and Flexet® 725 for the catalyst.

Alternately, a crosslinkable high ethylene content EPDM can be used as the abrasion resistant layer 4. The EPDM preferably contains from about 70 to about 95 weight percent ethylene and from about 3 to about 11 weight percent diene. The preferred diene is ethylidene norbornene. Preferably, the EPDM exhibits a crystallinity content of from about 8% to about 36%. A high ethylene content EPDM suitable for use in the preferred embodiment glass run channels is available from DuPont Dow Elastomers LLC, under the trade names Nordel® IP 4920, 4770 and 4720.

Regardless of which of the two above mentioned materials is used as the abrasion resistant layer 4 for the glass run channel, it can be applied to the main body member 2 in one of several different ways. For ease of description, the different processes will be described utilizing a two stage crosslinkable, silane-grafted polyethylene as the abrasion resistant layer 4 and EPDM as the thermoset elastomer rubber main body member 2. However, the present invention includes the use of other crosslinkable polyolefins as well as a high ethylene content EPDM as the abrasion resistant layer 4. Additionally, the present invention includes the use of an array of other thermoset elastomers besides those described above.

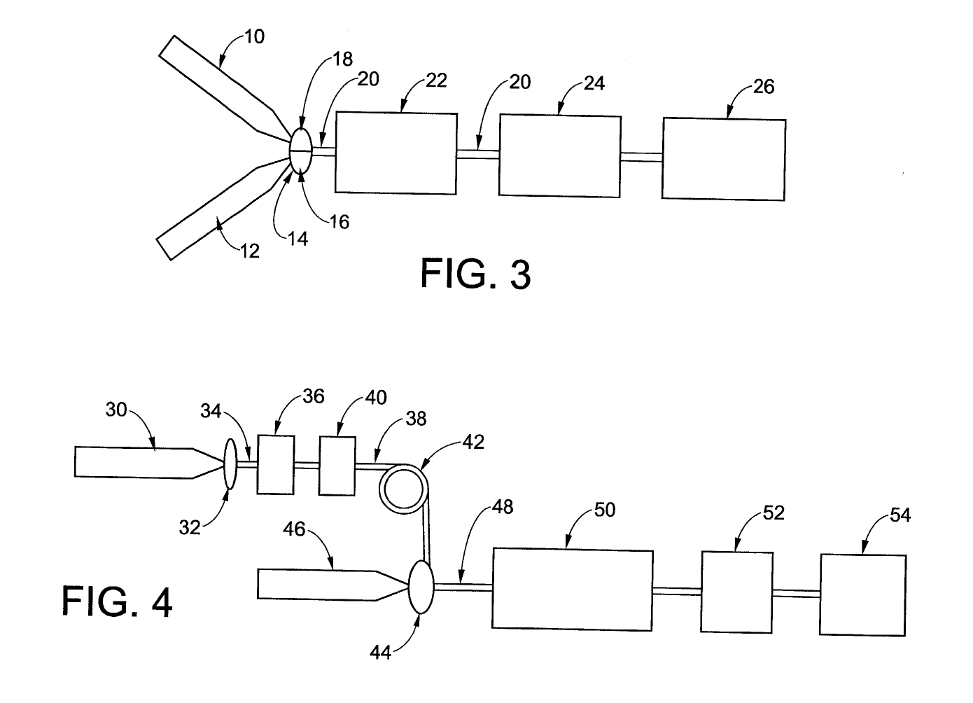

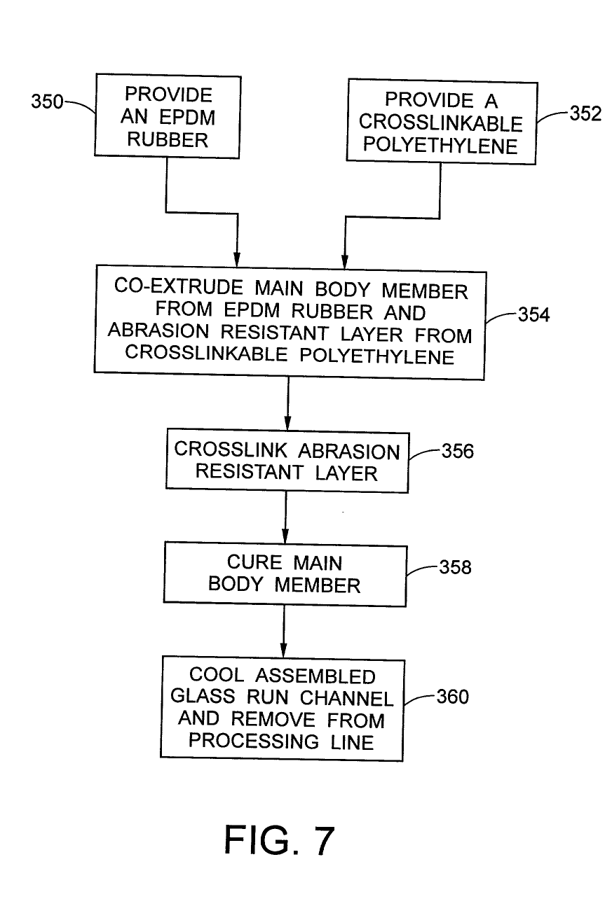

Referring to FIG. 3, the present invention also provides a first preferred technique for producing a composite extrusion by co-extruding an uncured EPDM main body member 2 and an uncrosslinked polyethylene abrasion resistant layer 4 through a common extrusion die. With reference to FIG. 7, a schematic diagram is shown outlining the processing steps in this first preferred technique. Briefly, an EPDM rubber and crosslinkable polyethylene are provided 350, 352. The EPDM rubber and the crosslinkable polyethylene are coextruded 354 to form a main body member 2 and an abrasion resistant layer 4, respectively. Subsequently, the crosslinkable polyethylene of the abrasion resistant layer is at least partially crosslinked 356. The EPDM rubber of the main body member is then at least partially cured 358 prior to removal of the assembly from the processing line 360.

With greater detail and with further reference to FIG. 3, a first extruder 10 for a silane-grafted crosslinkable polyethylene and a second extruder 12 for EPDM are placed in communication with a common extrusion die 14. To allow the EPDM compound to flow sufficiently to be extruded, the EPDM extruder 12 is preferably maintained at a temperature of from about 70° C. to about 85° C. For the same reason, the polyethylene extruder 10 is preferably maintained at about 160° C. to about 200° C. The extrusion die 14 is preferably maintained at about 110° C. on the EPDM side 16 and from about 200° C. to about 220° C. on the polyethylene side 18. Insulation (not shown) between the two sides of the extrusion die allows for this disparity in temperatures to be achieved. The EPDM and polyethylene are extruded at a pressure of from about 2000 to about 3000 psi. The polyethylene and EPDM are co-extruded such that the polyethylene mechanically bonds with the EPDM by partial melting and diffusion therewith. The thickness of the resulting polyethylene layer is from about 0.005 to about 0.040 inches, preferably from about 0.010 to about 0.020 inches and typically about 0.020 inches.

A resulting composite extrusion 20 comprising the extruded EPDM and polyethylene is then passed through a steam bath 22 to effect crosslinking of the polyethylene. The steam bath 22 is preferably at a temperature of from about 100° C. to about 110° C. To cure the EPDM, the composite extrusion 20 is then passed through an oven 24 at a temperature of from about 195° C. to about 300° C., depending on the grade of EPDM used in the main body member 2. Preferably, the total oven cure time is between about 1.3 and about 4 minutes. In a particularly preferred embodiment, the composite extrusion 20 is passed through a number of temperature zones in the oven 24 starting at about 195° C. for about 15 to about 50 seconds, ramping up to about 220° C. for about 45 seconds to about 2.4 minutes and then ramping down to about 195° C. for about 15 to about 50 seconds, prior to exiting the oven. The composite extrusion is then cooled in a water or air cooling tank 26 to about 30° C. to 60° C. before removing it from the manufacturing line.

In a second preferred technique in accordance with the present invention and illustrated in FIG. 4, the polyethylene is extruded into a tape and crosslinked prior to laminating it onto an uncured EPDM main body member. As used herein, the word “tape” and the words “tape member” are both used to designate a thin laminar structure having a generally uniform thickness. Preferably, the tape does not include the use of a separate adhesive to bond it to the main body member, although such use is contemplated and within the scope of the invention.

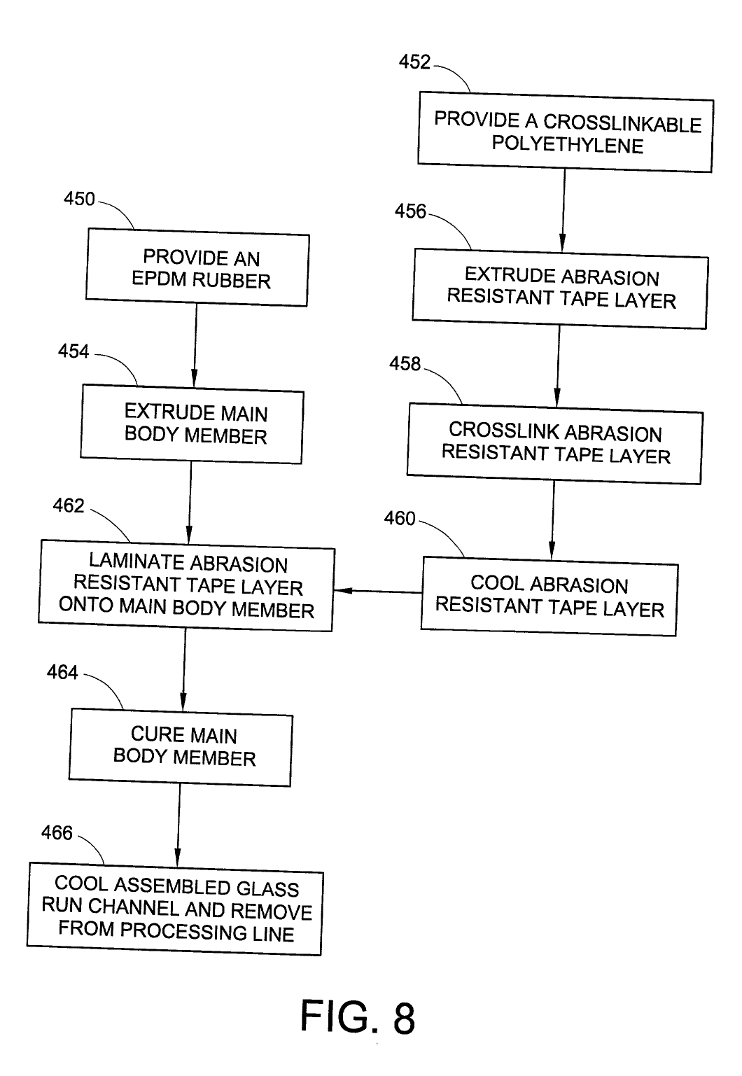

With reference to FIG. 8, a schematic diagram is shown outlining the processing steps in this second preferred technique. Briefly, an EPDM rubber and crosslinkable polyethylene are provided 450, 452. The EPDM rubber is extruded 454 into a main body member and the crosslinkable polyethylene is extruded 456 into an abrasion resistant tape layer. The abrasion resistant tape layer is at least partially crosslinked 458 and then cooled 460. The abrasion resistant tape layer is then laminated 462 onto the main body member. The main body member is subsequently cooled 464 prior to the assembly being removed 466 from the processing line.

With additional detail and with further reference to FIG. 4, the polyethylene is extruded from a polyethylene extruder 30 through a first die 32 into an uncured tape 34 and subsequently crosslinked in a steam bath 36. The at least partially crosslinked tape 38 is then cooled in a water cooling tank 40. The at least partially crosslinked tape 38 may be gathered at an accumulator 42 and is then subsequently laminated via a lamination die 44 onto a main body member made from uncured EPDM rubber extruded through the lamination die 44 from a rubber extruder 46. The rest of the process is similar to that described for the first embodiment, with the formed EPDM/polyethylene composite extrusion 48 passing through an oven 50 to cure the EPDM of the main body member and subsequently cooled down in a cool-down chamber 52 prior to removal from the manufacturing line 54. The temperatures and pressures for the second embodiment are preferably similar to those used for the first technique in all respects except that the lamination die 44 temperature is preferably at a temperature of from about 100° C. to about 120° C. and the cured polyethylene tape 38, just prior to lamination, is at a temperature of from about 30° C. to about 40° C.

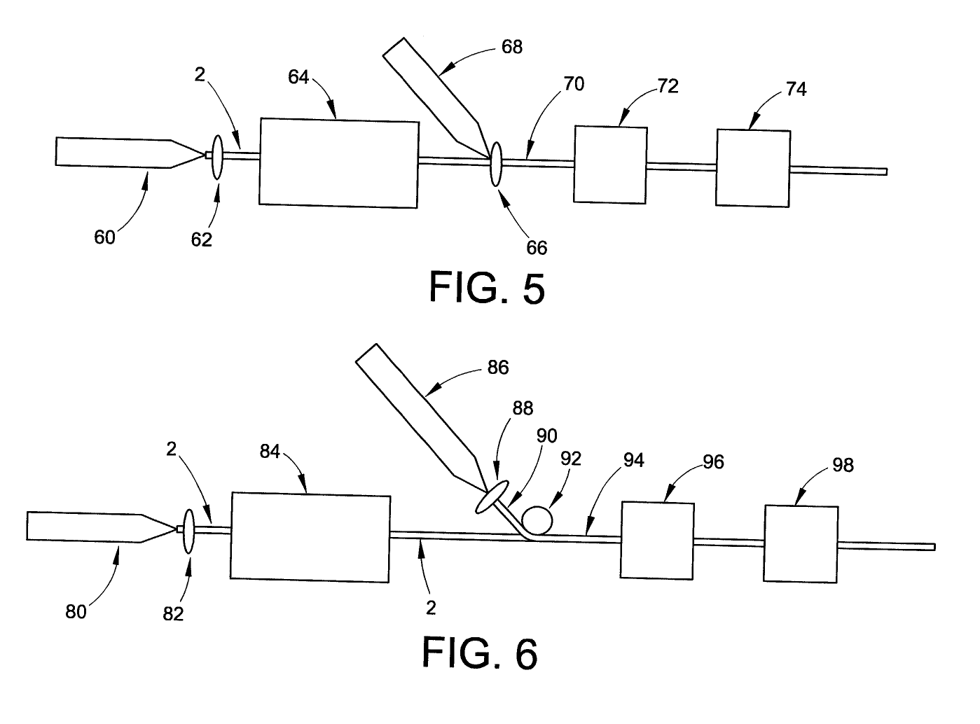

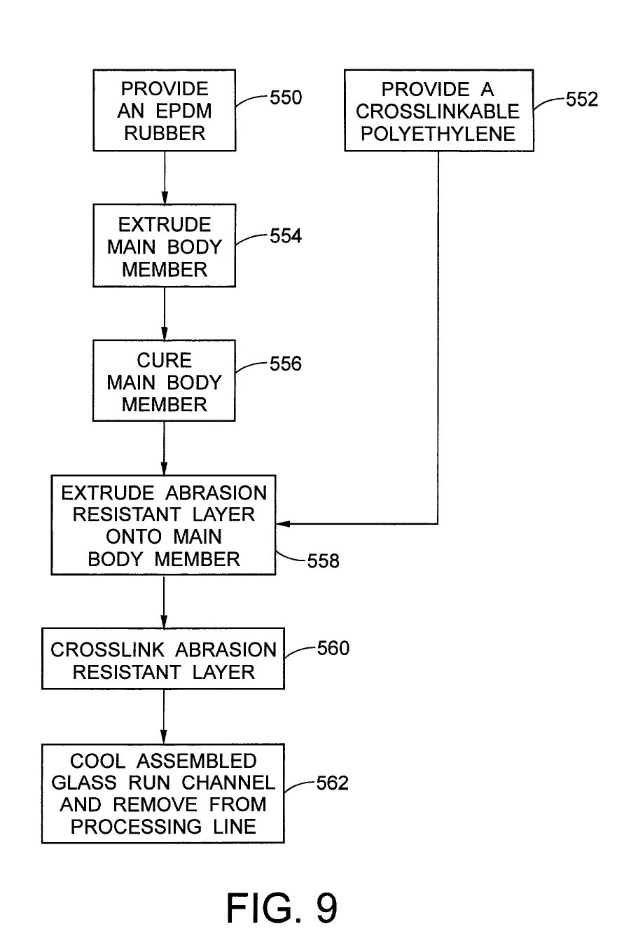

In a third preferred technique in accordance with the present invention, illustrated in FIG. 5, uncured polyethylene is extruded onto the main body member after the EPDM has been cured in the oven. With reference to FIG. 9, a schematic diagram is shown outlining the processing steps in this third preferred technique. Briefly, an EPDM rubber and crosslinkable polyethylene are provided 550, 552. The EPDM rubber is extruded 554 into a main body member and the main body member is subsequently at least partially cured 556. The crosslinkable polyethylene is extruded 558 as an abrasion resistant layer onto the main body member. The abrasion resistant layer is crosslinked 560 and cooled 562 prior to removal of the assembly from the processing line.

With additional detail and with further reference to FIG. 5, EPDM is extruded from a rubber extruder 60 through a first die 62 to form a main body member 2. The main body member 2 is then passed through an oven 64 to cure the EPDM. Upon emerging from the oven 64, an abrasion resistant layer comprising polyethylene is extruded through a second die 66 that is fed by a polyethylene extruder 68 onto the cured main body member 2 to form a composite extrusion 70. The composite extrusion 70 is passed through a steam bath 72 to crosslink the polyethylene and then passed through a cooling chamber 74 prior to take off from the manufacturing line. The temperatures and pressures for the third technique are preferably similar to those used for the first technique in all respects except that the first die 62 is at a temperature from about 100° C. to about 120° C. and the second die 66 is at a temperature from about 200° C. to about 220° C.

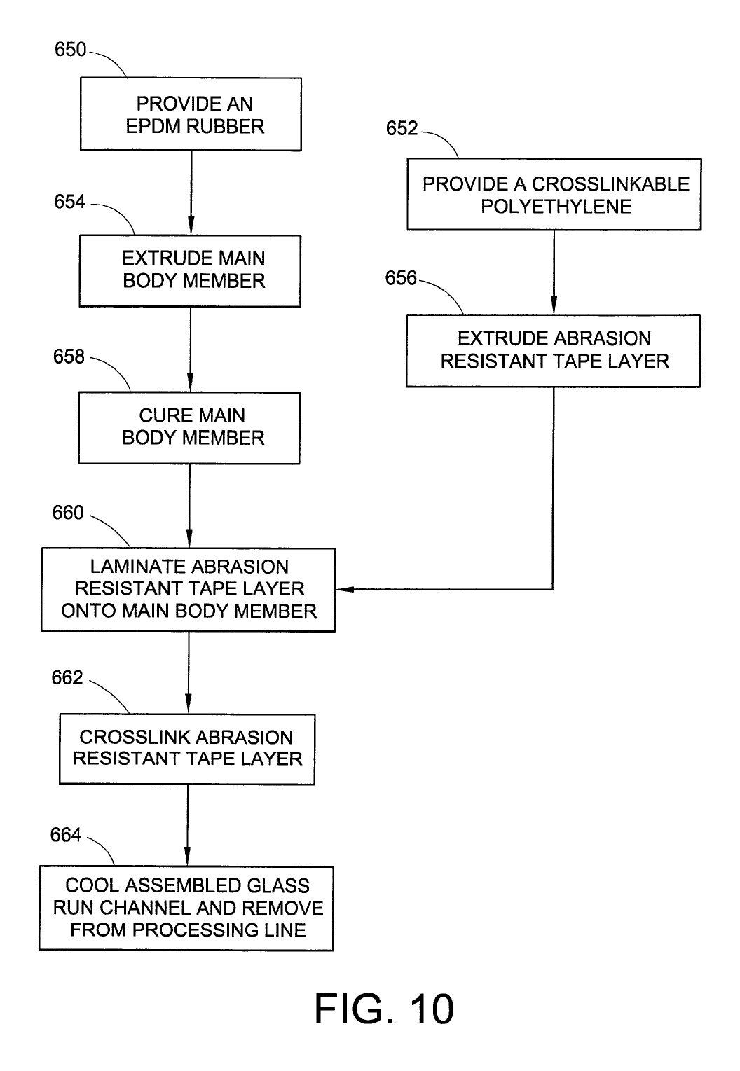

In a fourth technique, shown in FIG. 6, uncured polyethylene is extruded into a tape and then laminated onto a cured EPDM main body member. With reference to FIG. 10, a schematic diagram is shown outlining the processing steps in this fourth preferred technique. Briefly, a thermoset elastomer rubber and crosslinkable thermoplastic are provided 650, 652. The EPDM rubber is extruded 654 into a main body member and the crosslinkable polyethylene is extruded 656 into an abrasion resistant tape layer. The main body member is at least partially cured 658 and the abrasion resistant layer then laminated 660 onto the main body member. The abrasion resistant tape layer is then at least partially crosslinked 662 before the resultant assembly is cooled and removed 664 from the processing line.

With additional detail and with further reference to FIG. 6, EPDM from a rubber extruder 80 is extruded through a first die 82 into a main body member 2. The main body member 2 is passed through an oven 84 to cure it. Polyethylene is extruded from a second extruder 86 through a second die 88 to form an uncured abrasion resistant tape 90. A lamination wheel 92 then bonds the uncured polyethylene tape 90 to the main body member 2 to form a composite extrusion 94. The composite extrusion 94 is then passed through a steam bath 96 to crosslink the polyethylene tape 90 and then passed through a cooling chamber 98 prior to removal from the line. The temperatures and pressures for the fourth technique are preferably similar to those used for the first technique in all respects except that the first die 82 temperature is from about 100° C. to about 120° C., the second die 88 temperature is from about 200° C. to about 220° C. and the tape 90 temperature just prior to lamination is from about 80° C. to about 130° C.

While various changes and adaptations may be made to the above methods without departing from the scope of the invention, it is important to note that, with regard to the first two techniques described, the polyethylene is most preferably crosslinked prior to passing the composite extrusion through the oven to avoid excessive melting of the uncrosslinked polyethylene. As noted herein, a crosslinkable high ethylene content EPDM may used in place of the crosslinkable polyolefin as the abrasion resistant layer in the first two techniques described. If a crosslinkable high ethylene content EPDM is used to form the abrasion resistant layer then the steam bath previously described to crosslink the polyethylene in FIGS. 3 and 4 is replaced with a reaction chamber (not shown) where the EPDM is crosslinked using sulfur or peroxide curing agents.

The invention has been described with reference to various preferred embodiments. Modifications and alterations will occur to others upon a reading and understanding of the specification. The invention is intended to include all such modifications and alterations insofar as they come within the scope of the appended claims and the equivalents thereof. Thus, for example, composite extrusions for other weather seal profiles in addition to automobile glass run channels can be manufactured by the techniques of the present invention. In addition, the abrasion resistant layer may be colored to match surrounding parts.

What is claimed is:

1. A method for forming a composite extrusion suitable for use as a glass run channel in an automobile, the method comprising the steps of:
providing a thermoset elastomer rubber;
extruding said thermoset elastomer rubber to form a main body member;
providing a crosslinkable thermoplastic;
extruding said crosslinkable thermoplastic to form an abrasion resistant layer;
at least partially crosslinking said crosslinkable thermoplastic of said abrasion resistant layer;
contacting said abrasion resistant layer with said main body member; and
subsequent to contacting said abrasion resistant layer with said main body member, at least partially curing said main body member by heating said main body member to the cure temperature of said thermoset elastomer rubber, thereby forming said composite extrusion.

2. The method according to claim 1, wherein said crosslinkable thermoplastic is a moisture crosslinkable polyolefin.

3. The method according to claim 2, wherein said moisture crosslinkable polyolefin is a silane grafted polyethylene.

4. The method according to claim 2, wherein the step of at least partially crosslinking said moisture crosslinkable polyolefin is performed by immersing said abrasion resistant layer in a steam bath.

5. The method according to claim 4, wherein the step of extruding said thermoset elastomer rubber is performed utilizing an extrusion temperature of about 110° C., the step of extruding said crosslinkable thermoplastic is performed utilizing an extrusion temperature of from about 200° C. to about 220° C., the step of immersing said abrasion resistant layer in a steam bath is performed by utilizing said steam bath at a temperature of from about 100° C. to about 110° C. and the step of at least partially curing said main body member by heating said main body member is performed by heating said body member to a temperature of from about 195° C. to about 300° C.

6. The method according to claim 5, wherein the step of at least partially curing said main body member by heating said main body member is performed by heating said main body member to a temperature of about 195° C., maintaining said main body member at about 195° C. for about 15 to about 50 seconds, further heating said main body member to a temperature of about 220° C., maintaining said main body member at about 220° C. for about 45 seconds to about 2.4 minutes, and then cooling said main body member to a temperature of about 195° C. and maintaining said main body member at about 195° C. for about 15 to about 50 seconds.

7. The method according to claim 1, wherein said contacting step is performed after said step of at least partially crosslinking said crosslinkable thermoplastic of said abrasion resistant layer.

8. The method according to claim 1, wherein said contacting step is performed before said step of at least partially crosslinking said crosslinkable thermoplastic of said abrasion resistant layer.

9. The method according to claim 1, wherein the steps of extruding said thermoset elastomer rubber and extruding said crosslinkable thermoplastic are performed by simultaneously extruding said thermoset elastomer rubber and said crosslinkable thermoplastic through a common extrusion die.

10. The method according to claim 1, wherein said abrasion resistant layer is a tape member.

11. The method according to claim 10, further comprising a lamination step wherein said tape member is laminated to said main body member by use of a lamination wheel.

12. The method according to claim 1, wherein the step of providing a thermoset elastomer rubber is performed by providing an ethylene-propylene-diene terpolymer (EPDM) rubber.

13. The method according to claim 1, wherein the thickness of said abrasion resistant layer is from about 0.005 to about 0.040 inches.

14. The method according to claim 13, wherein the thickness of said abrasion resistant layer is from about 0.010 to about 0.020 inches.

15. A method for forming a composite extrusion suitable for use as a glass run channel in an automobile, the method comprising the steps of:
providing a thermoset elastomer rubber;
extruding a main body member from said thermoset elastomer rubber;
providing a crosslinkable thermoplastic;
extruding an abrasion resistant layer from said crosslinkable thermoplastic at a temperature of from about 200° C. to about 220° C.;
contacting said abrasion resistant layer with said main body member;
at least partially crosslinking said crosslinkable thermoplastic of said abrasion resistant layer; and
at least partially curing said main body member by heating said main body member to the cure temperature of said thermoset elastomer rubber, thereby forming the composite extrusion.

16. The method according to claim 15, wherein said crosslinkable thermoplastic is a moisture crosslinkable polyolefin.

17. The method according to claim 16, wherein said moisture crosslinkable polyolefin is a silane grafted polyethylene.

18. The method according to claim 16, wherein the step of at least partially crosslinking said crosslinkable thermoplastic of said abrasion resistant layer is performed by immersing said abrasion resistant layer in a steam bath.

19.The method according to claim 18, wherein the step of extruding said main body member is performed at an extrusion temperature of about 110° C., the step of immersing said abrasion resistant layer in a steam bath is performed at a steam bath temperature of from about 100° C. to about 110° C. and the step of at least partially curing said main body member by heating said main body member is performed by heating the main body member to a temperature of from about 195° C. to about 300° C.

20. The method according to claim 19, wherein the step of at least partially curing said main body member by heating said main body member is performed by heating said main body member to a temperature of about 195° C., maintaining said main body member at about 195° C. for about 15 to about 50 seconds, further heating said main body member to a temperature of about 220° C., maintaining said main body member at about 220° C. for about 45 seconds to about 2.4 minutes, and then cooling said main body member to a temperature of about 195° C. and maintaining said main body member at about 195° C. for about 15 to about 50 seconds.

21. The method according to claim 15, wherein the contacting step is performed after the step of at least partially crosslinking said thermoplastic of said abrasion resistant layer.

22. The method according to claim 15, wherein the contacting step is performed before the step of at least partially crosslinking said thermoplastic of said abrasion resistant layer.

23. The method according to claim 15, wherein the steps of extruding said thermoset elastomer rubber and said crosslinkable thermoplastic are performed by simultaneously extruding said thermoset elastomer rubber and said crosslinkable thermoplastic through a common extrusion die.

24.The method according to claim 15, wherein said main body member is cured prior to contacting said abrasion resistant layer with said main body member.

25. The method according to claim 15, wherein said main body member is cured subsequent to contacting said abrasion resistant layer with said main body member.

26. The method according to claim 15, wherein said abrasion resistant layer is a tape member.

27. The method according to claim 26, further comprising a lamination step wherein said tape member is laminated to said main body member by use of a lamination wheel.

28. The method according to claim 15, wherein said thermoset elastomer rubber is an ethylene-propylene-diene terpolymer (EPDM) rubber.

29. The method according to claim 15, wherein the thickness of said abrasion resistant layer is from about 0.005 to about 0.040 inches.

30. The method according to claim 29, wherein the thickness of the abrasion resistant layer is from about 0.010 to about 0.020 inches.

31. A method for forming a composite extrusion suitable for use as a glass run channel in an automobile, the method comprising the steps of:
providing a thermoset elastomer rubber;
extruding a main body member from the thermoset elastomer rubber;
providing an abrasion resistant layer comprising a high ethylene content ethylene-propylene-diene terpolymer (EPDM) rubber that comprises from about 70 to about 95 weight percent ethylene and from about 3 to about 11 weight percent diene and having a crystallinity of from about 8% to about 36% percent;
contacting the abrasion resistant layer with the main body member; and
at least partially curing the thermoset elastomer rubber by heating the main body member to the cure temperature of the thermoset elastomer rubber, thereby forming the composite extrusion.

32. The method according to claim 31, wherein said high ethylene content EPDM comprises ethylidene norbornene as its diene component.

33. The method according to claim 31, wherein the contacting step is performed after said high ethylene content EPDM is crosslinked.

34.The method according to claim 31, wherein the contacting step is performed before said high ethylene content EPDM is crosslinked.

35. The method according to claim 31, wherein the contacting step is performed before said thermoset elastomer rubber of said main body member is cured.

36. The method according to claim 31, wherein said abrasion resistant layer is a tape member.

37. The method according to claim 36, further comprising a lamination step wherein said tape member is laminated to said main body member by use of a lamination wheel.

38. The method according to claim 31, wherein said thermoset elastomer rubber is an ethylene-propylene-diene terpolymer (EPDM).

39. The method according to claim 31, wherein the thickness of said abrasion resistant layer is from about 0.005 to about 0.040 inches.

40. The method according to claim 39, wherein the thickness of said abrasion resistant layer is from about 0.010 to about 0.020 inches.

41. A wear resistant composite extrusion suitable for use as a glass run channel in an automobile comprising an abrasion resistant layer comprised of high ethylene content EPDM secured to and disposed immediately adjacent a main body member comprising an at least partially cured thermoset elastomer rubber, said high ethylene content EPDM including from about 70 to about 95 weight percent ethylene and from about 3 to about 11 weight percent diene and having a crystallinity of from about 8% to about 36%.

42. A wear resistant composite extrusion adapted for use as a glass run channel in an automobile, said wear resistant composite extrusion comprising:
a main body member comprising a thermoset elastomer rubber and having a bottom wall disposed between and joined to a first side wall and a second side wall, said second side wall oppositely located from said first side wall, each of said first and second side walls transversely extending from said bottom wall and including an inwardly projecting seal lip and a plurality of outwardly projecting retention spurs; and
an abrasion resistant layer secured to said bottom wall of said main body member, said abrasion resistant layer comprising a crosslinkable thermoplastic and having a thickness of from about 0.005 to about 0.040 inches.

43. The composite extrusion according to claim 42, wherein said thermoplastic is a moisture crosslinkable polyolefin.

44. The composite extrusion according to claim 43, wherein said moisture crosslinkable polyolefin is a silane grafted polyethylene.

45. The composite extrusion according to claim 43, wherein said moisture crosslinkable polyolefin is at least partially crosslinked.

46. The composite extrusion according to claim 42, wherein said abrasion resistant layer is in the form of a tape member having a thin laminar design with a generally uniform thickness of from about 0.005 to about 0.040 inches.

47. A wear resistant composite extrusion suitable for use as a glass run channel in an automobile comprising an extruded and at least partially cured high ethylene content EPDM abrasion resistant layer and an extruded and at least partially cured thermoset elastomer rubber main body member, said main body member comprising a bottom wall and two transversely extending side walls joined to opposite sides of said bottom wall, each side wall equipped with an inwardly projecting seal lip and a plurality of outwardly projecting retention spurs, said abrasion resistant layer bonded to and disposed adjacent said bottom wall of said main body member, said high ethylene content EPDM including from about 70 to about 95 weight percent ethylene and from about 3 to about 11 weight percent diene and having a crystallinity of from about 8% to about 36%, and the thickness of said abrasion resistant layer is from about 0.005 to about 0.040 inches.

48. A glass run channel for receiving and retaining a window, said glass run channel comprising:
(A) a thermoset elastomer rubber main body member having
(i) a bottom wall defining a first longitudinal edge, a second opposite longitudinal edge, a top surface extending between said first edge and said second edge, and a bottom surface opposite from said top surface, said bottom surface also extending between said first edge and said second edge,
(ii) a first side wall having a first end and a second opposite end, said first end contiguous with said first edge of said bottom wall and extending generally transversely with respect to said bottom wall,
(iii) a second side wall having a first end and a second opposite end, said first end contiguous with said second edge of said bottom wall and extending generally transversely with respect to said bottom wall,
(iv) a first sealing lip contiguous with said second end of said first side wall and extending generally transversely with respect to said first side wall,
(v) a second sealing lip contiguous with said second end of said second side wall and extending generally transversely with respect to said second side wall, wherein said bottom wall, said first and second side walls, and said first and second sealing lips define an interior chamber accessible by moving at least one of said first and second sealing lips; and
(B) a layer of an at least partially crosslinked abrasion resistant material disposed on said top surface of said bottom wall of said main body member and exposed to said interior chamber, said abrasion resistant material selected from the group consisting of a moisture crosslinkable polyolefin and a high ethylene content EPDM, and said layer having a thickness of from about 0.005 to about 0.040 inches.
